(19) United States
(12) Patent Application Publication
(10) Pub. No.: US 2026/0352398 A1
(43) Pub. Date: Nov. 5, 2026

(54) METHOD AND APPARATUS FOR REQUESTING ON-DEMAND POSITIONING SYSTEM INFORMATION BLOCKS

(71) Applicant: Mentats Co., Ltd., Seoul (KR)

(72) Inventor: DaeHeum PARK, Suwon-si (KR)

(21) Appl. No.: 19/557,621

(22) Filed: Mar. 5, 2026

(30) Foreign Application Priority Data
May 2, 2025 (KR) 10-2025-0058549

(51) Int. Cl. H04L 5/00; H04W 64/00

(52) U.S. Cl. CPC H04L 5/0048; H04W 64/00

(57) ABSTRACT

Described are a method and apparatus for requesting on-demand positioning system information blocks in a wireless communication system. A terminal may receive, through a first message, first information indicating that the terminal is enabled to request periodic delivery of at least one positioning system information block (SIB), transmit, through a second message, a first request requesting the periodic delivery of the at least one positioning SIB according to the first information, determine that the periodic delivery of the at least one positioning SIB is no longer required, and transmit, through the second message, a second request requesting stopping the periodic delivery of the at least one positioning SIB.

### CROSS-REFERENCE TO RELATED APPLICATIONS

This application claims the priority of Korean Patent Application No. 10-2025-0058549 filed on May 2, 2025, in the Korean Intellectual Property Office, the disclosure of which is incorporated herein by reference.

### BACKGROUND OF THE DISCLOSURE

### Field of the Disclosure

The present disclosure relates to a wireless communication system applicable to 4G, 5G and 6G.

### Related Art

With the continuous development of mobile communication technologies, the transition from 4G to 5G has brought about significant improvements in various aspects of wireless communication. These advancements are designed to meet the ever-growing demands of modern applications, such as high-speed mobile broadband, massive connectivity for Internet of Things (IoT) devices, and ultra-reliable low-latency communications. The key areas of development in 5G can be categorized into enhanced Mobile Broadband (eMBB), massive Machine Type Communications (mMTC), and Ultra-Reliable Low-Latency Communications (URLLC), each addressing distinct use cases and requirements that were challenging for 4G technologies.

Enhanced Mobile Broadband (eMBB)

In 4G, Long-Term Evolution (LTE) technology provided high-speed mobile broadband, with peak download speeds reaching up to 1 Gbps. While this met the needs of high-definition video streaming, mobile gaming, and other data-intensive services, the increasing demand for higher speeds and larger data volumes necessitated further innovation. 5G addresses these challenges by offering up to 20 Gbps download speeds, enabling new applications such as 4K/8K video streaming, virtual reality (VR), augmented reality (AR), and large-scale data transfers. The introduction of technologies such as massive MIMO, beamforming, and the use of millimeter-wave frequencies have enabled 5G to deliver these improved capabilities, meeting the growing demand for mobile broadband.

Massive Machine Type Communications (mMTC)

The emergence of the Internet of Things (IoT) has brought about the need for a vast number of connected devices. However, 4G LTE technology was not optimized for massive device connectivity, as it primarily focused on human-to-human communication. Moreover, 4G faced limitations in terms of energy efficiency, scalability, and the ability to handle a large number of connected devices simultaneously. 5G addresses these issues by introducing mMTC, which supports the connection of millions of devices with minimal energy consumption and long battery life. By utilizing Low-Power Wide-Area Networks (LPWAN) and network slicing, 5G ensures efficient connectivity for massive IoT deployments, including smart cities, agriculture, healthcare, and other large-scale IoT ecosystems.

### Ultra-Reliable Low-Latency Communications (URLLC)

4G networks, while offering low latency for mobile broadband, were not optimized for ultra-reliable and real-time communication, which is essential for applications such as autonomous driving, remote surgery, and industrial automation. The need for ultra-reliable, low-latency communication with near-instantaneous response times prompted the development of URLLC in 5G. With 5G, latency is reduced to as low as 1 millisecond, enabling real-time communication and control. This advancement is critical for applications that require immediate decision-making, such as autonomous vehicles that rely on real-time vehicle-to-vehicle and vehicle-to-infrastructure communication, as well as remote medical procedures and industrial automation systems that require precise, instantaneous control.

These developments have made 5G a pivotal technology in transforming the way industries operate and society interacts with the digital world. The ongoing evolution from 4G to 5G represents a significant leap forward in enabling new use cases, increasing network efficiency, and enhancing user experience.

Looking ahead, 6G is expected to further expand the capabilities of 5G, focusing on even higher speeds, ultra-high reliability, and the integration of advanced technologies like AI and holographic communications. It is anticipated that 6G will enable more immersive and seamless experiences, such as truly ubiquitous connectivity, advanced immersive technologies like mixed reality (XR), and autonomous systems that operate in real-time with zero latency. The evolution from 4G to 5G and eventually to 6G highlights the continuous progress in wireless communication technologies and their increasing role in shaping the future of the digital world.

### SUMMARY OF THE DISCLOSURE

The disclosure is to provide a method and apparatus for efficiently operating a terminal for requesting on-demand positioning system information blocks in a wireless communication system.

According to an embodiment, a method of a terminal may be provided for operating in a wireless communication system. The method of the terminal may include receiving, through a first message, first information indicating that the terminal is enabled to request periodic delivery of at least one positioning system information block (SIB), transmitting, through a second message, a first request requesting the periodic delivery of the at least one positioning SIB according to the first information, determining that the periodic delivery of the at least one positioning SIB is no longer required, and transmitting, through the second message, a second request requesting stopping the periodic delivery of the at least one positioning SIB.

According to another embodiment, a terminal may be provided for operating in a wireless communication system. The terminal may include a processor configured to cause the terminal to receive, through a first message, first information indicating that the terminal is enabled to request periodic delivery of at least one positioning system information block (SIB), transmit, through a second message, a first request requesting the periodic delivery of the at least one positioning SIB according to the first information, determine that the periodic delivery of the at least one positioning SIB is no longer required, and transmit, through the second message, a second request requesting stopping the periodic delivery of the at least one positioning SIB.

The first information may be received only when the first message includes second information indicating that the terminal is allowed to request at least one SIB.

Further, The first request and the second request may be transmitted using a same field in the second message.

The at least one positioning SIB may comprise, among a positioning SIB of type 6-1, a positioning SIB of type 6-2, a positioning SIB of type 6-3, a positioning SIB of type 6-4, a positioning SIB of type 6-5, a positioning SIB of type 6-6 and a positioning SIB of type 6-7, only the positioning SIB of type 6-7.

The at least one positioning SIB may further comprise at least one selected from a first set consisting of a positioning SIB of type 1-10 and a positioning SIB of type 1-12.

The at least one positioning SIB may further comprise at least one selected from a second set consisting of a positioning SIB of type 2-12, a positioning SIB of type 2-13, a positioning SIB of type 2-14, a positioning SIB of type 2-15, a positioning SIB of type 2-16, a positioning SIB of type 2-17, a positioning SIB of type 2-17bis, a positioning SIB of type 2-18, a positioning SIB of type 2-18bis, a positioning SIB of type 2-19, a positioning SIB of type 2-20, a positioning SIB of type 2-20bis, a positioning SIB of type 2-21, a positioning SIB of type 2-22 and a positioning SIB of type 2-23.

### BRIEF DESCRIPTION OF THE DRAWINGS

FIG. 1 illustrates a wireless communication system.

FIG. 2 illustrates UE state machine and state transitions in NR.

FIG. 3 illustrates a procedure of system information acquisition.

FIG. 4 illustrates a procedure of terminal capability transfer.

FIG. 5 illustrates a procedure between a terminal and a base station according to an embodiment of the disclosure.

FIG. 6 is a block diagram showing apparatuses according to an embodiment of the disclosure.

### DESCRIPTION OF EXEMPLARY EMBODIMENTS

The technical terms used in this disclosure are intended to describe specific embodiments and should not be construed as limiting. Unless otherwise defined, these terms should be interpreted according to their generally understood meanings by those skilled in the art, without being overly broad or narrow. If a term does not fully represent the spirit of the disclosure, it should be understood as the most accurate technical term recognized by those skilled in the art.

The use of a slash (/) or a comma in the present disclosure may represent “and/or.” For example, “A/B” may indicate “A and/or B,” meaning it can refer to “only A,” “only B,” or “both A and B.”.

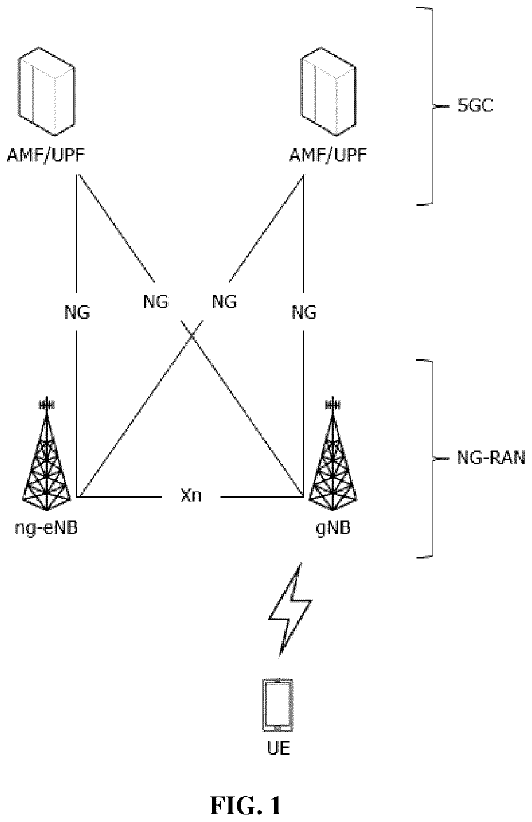

FIG. 1 illustrates a wireless communication system.

Referring to FIG. 1, the wireless communication system may be classified into a 5G core network (5GC) and a next generation-radio access network (NG-RAN), and the NG-RAN may include a base station (gNB and/or ng-eNB) that provides user plane and control plane protocol termination to a terminal (user equipment, UE). A next generation-Node B (gNB) provides an NR user plane and control plane protocol termination to the terminal, and a next generation-evolved node B (ng-eNB) provides an evolved-universal terrestrial radio access (E-UTRA) user plane and control plane protocol termination to the terminal (UE). The terminal (UE) may be fixed or mobile, and may be referred to as another term such as a mobile station (MS), a user terminal (UT), a subscriber station (SS), a mobile terminal (MT), a wireless device, etc. The base station (gNB and/or ng-eNB) may be a fixed station communicating with the terminal (UE), and may be referred to as another term such as a base transceiver system (BTS), an access point, etc.

The base station (gNB and/or ng-eNB) may be connected to each other through an Xn interface, and may be connected to a 5G core network (5GC) through an NG interface. Specifically, the base station (gNB and/or ng-eNB) may be connected to an access and mobility management function (AMF) through an NG-C interface, and may be connected to a user plane function (UPF) through an NG-U interface.

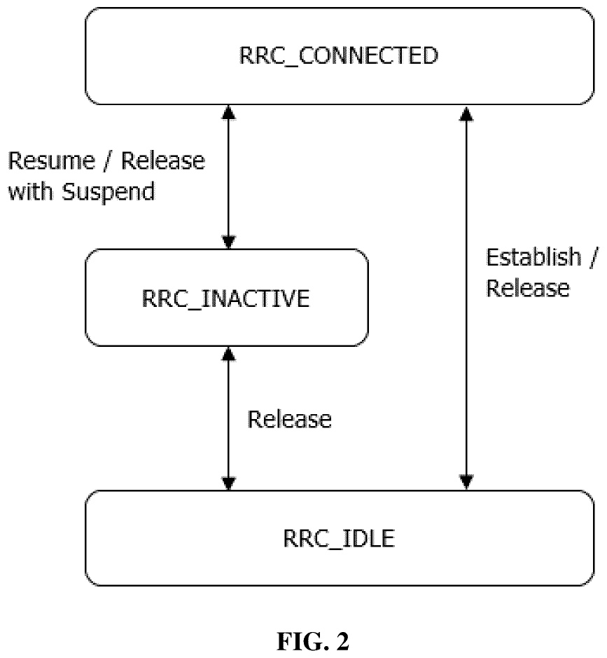

FIG. 2 illustrates UE state machine and state transitions in NR.

A UE is either in RRC_CONNECTED state or in RRC_INACTIVE state when an RRC connection has been established. If this is not the case, i.e. no RRC connection is established, the UE is in RRC_IDLE state. The RRC states can further be characterised as follows:

### 1. RRC_IDLE:

A UE specific DRX (Discontinuous Reception) may be configured by upper layers;
At lower layers, the UE may be configured with a DRX for PTM (Point to Multipoint) transmission of MBS (Multicast/Broadcast Services) broadcast;
UE controlled mobility based on network configuration;
The UE:
i) Monitors Short Messages transmitted with P-RNTI (Paging-RNTI) over DCI (Downlink Control Information);
ii) Monitors a Paging channel for CN (Core Network) paging using 5G-S-TMSI (5G-Serving-Temporary Mobile Subscriber Identity), except if the UE is acting as a L2 (Layer 2) U2N (UE-to-Network) Remote UE;
iii) If configured by upper layers for MBS multicast reception, monitors a Paging channel for CN paging using TMGI (Temporary Mobile Group Identity);
iv) Performs neighbouring cell measurements and cell (re-)selection;
v) Performs measurements on L2 U2N Relay UEs and relay (re-)selection;
vi) Acquires system information and can send SI request (if configured);
vii) Performs logging of available measurements together with location and time for logged measurement configured UEs;
viii) Performs idle/inactive measurements for idle/inactive measurement configured UEs;
ix) If configured by upper layers for MBS broadcast reception, acquires MCCH change notification and MBS broadcast control information and data.

### 2. RRC_INACTIVE:

A UE specific DRX may be configured by upper layers or by RRC layer;
At lower layers, the UE may be configured with a DRX for PTM transmission of MBS broadcast and/or a DRX for PTM transmission of MBS multicast;
UE controlled mobility based on network configuration;
The UE stores the UE Inactive AS (Access Stratum) context;
A RAN-based notification area is configured by RRC layer;
Transfer of unicast data and/or signalling to/from UE over radio bearers configured for SDT.
The UE:
i) Monitors Short Messages transmitted with P-RNTI over DCI;
ii) While T319a is running, monitors control channels associated with the shared data channel to determine if data is scheduled for it;
iii) While T319a is not running, monitors a Paging channel for CN paging using 5G-S-TMSI and RAN paging using fullI-RNTI (full Inactive RNTI), except if the UE is acting as a L2 U2N Remote UE;
iv) If configured by upper layers for MBS multicast reception, while T319a is not running, monitors a Paging channel for paging using TMGI;
v) Performs neighbouring cell measurements and cell (re-)selection;
vi) Performs measurements on L2 U2N Relay UEs and relay (re-)selection;
vii) Performs RAN-based notification area updates periodically and when moving outside the configured RAN-based notification area;
viii) Acquires system information and, while SDT (Small Data Transmission) procedure is not ongoing, can send SI (System Information) request (if configured);
ix) While SDT procedure is not ongoing, performs logging of available measurements together with location and time for logged measurement configured UEs;
x) While SDT procedure is not ongoing, performs idle/inactive measurements for idle/inactive measurement configured UEs;
xi) If configured by upper layers for MBS broadcast reception, acquires MCCH (MBS Control Channel) change notification and MBS broadcast control information and data;
xii) If configured for MBS multicast reception in RRC_INACTIVE, acquires multicast MCCH change notification and MBS multicast control information and data;
xiii) Transmits SRS (Sounding Reference Signal) for Positioning.

### 3. RRC_CONNECTED:

The UE stores the AS context;
Transfer of unicast data to/from UE;
Transfer of MBS multicast data to UE;
At lower layers, the UE may be configured with a UE specific DRX;
At lower layers, the UE may be configured with a DRX for PTM transmission of MBS broadcast and/or a DRX for MBS multicast;
At lower layers, the UE may be configured with a cell specific cell DTX/DRX;
For UEs supporting CA (Carrier Aggregation), use of one or more SCells (Secondary Cells), aggregated with the SpCell (Special Cell), for increased bandwidth;
For UEs supporting DC (Dual Connectivity), use of one SCG (Secondary Cell Group), aggregated with the MCG (Master Cell Group), for increased bandwidth;
Network controlled mobility within NR, to/from E-UTRA, and to UTRA-FDD;
Network controlled mobility (path switch) between a serving cell and a L2 U2N Relay UE, or vice versa, or between a source L2 U2N Relay UE and a target L2 U2N Relay UE;
Network controlled MP (Multi-Path) operation.
The UE:
i) Monitors Short Messages transmitted with P-RNTI over DCI, if configured;
ii) Monitors control channels associated with the shared data channel to determine if data is scheduled for it;
iii) Provides channel quality and feedback information;
iv) Performs neighbouring cell and/or L2 U2N relay measurements and measurement reporting;
v) Acquires system information;
vi) Performs immediate MDT measurement together with available location reporting;
vii) If configured by upper layers for MBS broadcast reception, acquires MCCH change notification and MBS broadcast control information and data

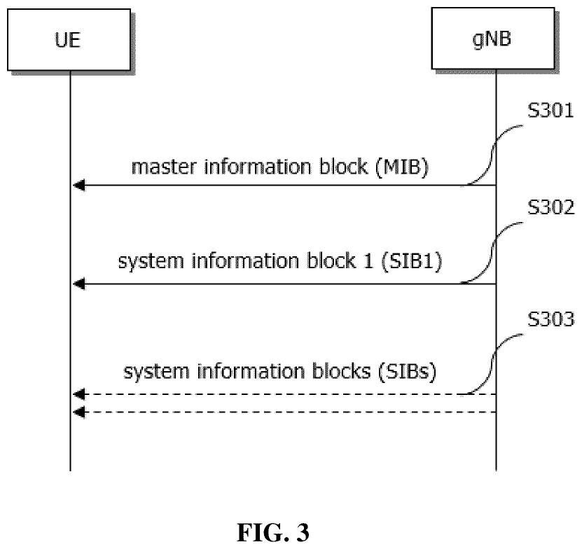

FIG. 3 illustrates a procedure of system information acquisition.

System Information (SI) may be divided into a master information block (MIB), a system information block 1 (SIB1) and a number of SIBs. The MIB contains cell barred status information and essential physical layer information of the cell required to receive further system information. The MIB is always transmitted on the broadcast channel (BCH) periodically (S301). The SIB1 defines the scheduling of other system information blocks and contains information required for initial access. The SIB1 is also referred to as Remaining Minimum SI (RMSI) and is periodically broadcast on downlink shared channel (DL-SCH) or sent in a dedicated manner on DL-SCH to UEs in RRC_CONNECTED (S302). The SIBs can either be periodically broadcast on DL-SCH, broadcast on-demand on DL-SCH or sent in a dedicated manner on DL-SCH to UEs in RRC_CONNECTED (S303).

### <Positioning and Assistance Data>

Positioning in wireless communication systems, such as 5G New Radio (NR), refers to the process of estimating the geographic coordinates or spatial orientation of a UE. This is achieved through a coordinated exchange of signals and data between the UE and the network (e.g., Location Management Function, LMF). Modern positioning leverages multiple technologies, including Global Navigation Satellite Systems (GNSS), terrestrial cellular signals, and sensor-based data, to provide high-precision location services for emergency response, industrial automation, and navigation.

Assistance Data is a set of parameters provided by the network to the UE to enhance the efficiency, accuracy, and speed of the positioning process. By delivering information such as satellite orbits, base station coordinates, or precise timing offsets, the network enables the UE to reduce its search space and processing load. In 5G systems, this data may be broadcast via Positioning System Information Blocks (posSIBs), allowing multiple UEs to access necessary information simultaneously without dedicated signaling overhead.

The various posSIB types are described as follows.

### 1. GNSS Common Assistance Data

Positioning SIBs of types 1-1 to 1-12 (posSibType1-1 to posSibType1-12) provide fundamental control and common parameters applicable across multiple GNSS constellations (e.g., GPS, Galileo, GLONASS). These include information related to the scheduling of other positioning SIBs, reference time, ionospheric delay models, and Earth orientation parameters. These blocks serve as a baseline enabling a UE to synchronize its internal clock with GNSS constellations and to compensate for ionospheric and atmospheric signal delays.

### 2. GNSS Generic Assistance Data

Positioning SIBs of types 2-1 to 2-27 (posSibType2-1 to posSibType2-27) deliver satellite-specific and constellation-specific orbit information. They provide detailed ephemeris data, satellite clock correction parameters, and almanac data. By utilizing these generic assistance parameters, a UE can more precisely predict satellite positions and velocities, thereby significantly reducing Time-To-First-Fix (TTFF) and improving positioning accuracy and reliability.

### 3. OTDOA Assistance Data

The positioning SIB of type 3-1 (posSibType3-1) is dedicated to Observed Time Difference of Arrival (OTDOA) positioning, which is primarily used in LTE and is also supported in NR systems. It provides information regarding Positioning Reference Signals (PRS) transmitted by neighboring cells, including frequency configuration, timing offsets, and muting patterns. This enables the UE to measure time differences between signals received from multiple base stations and to determine its position through multilateration.

### 4. Barometric Assistance Data

The positioning SIB of type 4-1 (posSibType4-1) provides barometric pressure information corresponding to one or more predefined reference locations. This information may be used by a UE to improve vertical positioning accuracy, i.e., altitude estimation. By comparing locally measured atmospheric pressure obtained from an internal sensor with the reference pressure information provided in this SIB, the UE can estimate its relative height, for example with respect to sea level or relative vertical positioning within a building.

### 5. TBS Assistance Data

The positioning SIB of type 5-1 (posSibType5-1) provides assistance data for Terrestrial Beacon Systems (TBS), such as the Metropolitan Beacon System (MBS). It includes location information and transmission parameters of ground-based beacons that operate independently of the cellular radio access network. Such assistance data may be particularly useful in environments where GNSS signals are weak, obstructed, or unavailable, for example in dense urban environments or indoor facilities.

### 6. NR DL Positioning & AI/ML Assistance Data

Positioning SIBs of types 6-1 to 6-5 and 6-7 (posSibType6-1 to posSibType6-5 and posSibType6-7) are associated with 5G NR downlink positioning methods, including Downlink Time Difference of Arrival (DL-TDOA) and Downlink Angle of Departure (DL-AoD). These blocks provide configuration information related to NR Positioning Reference Signal (NR-PRS) resource sets and beam management parameters. In some implementations, they may further include configuration information usable for AI/ML-assisted positioning, such as metadata supporting machine learning-based signal fingerprinting or multipath mitigation techniques.

### 7. On-demand DL-PRS Configurations

The positioning SIB of type 6-6 (posSibType6-6) provides support for on-demand Positioning Reference Signal (PRS) configurations. Unlike statically broadcast PRS configurations, this mechanism enables the network to dynamically configure and signal PRS resources based on positioning requirements or UE distribution within a cell. Such a mechanism may improve radio resource efficiency by allocating or activating PRS transmissions only when positioning procedures are initiated or requested.

### 8. Integrity Assistance Data

Positioning SIBs of types 7-1 to 7-3 (posSibType7-1 to posSibType7-3) provide integrity assistance data for various NR positioning methods. Such integrity information may be particularly important for safety-of-life or safety-critical applications, such as autonomous driving systems. The integrity assistance data may include error bounds, integrity status indicators, and protection level parameters associated with GNSS and terrestrial measurements. This information enables a UE to determine whether positioning results satisfy predefined integrity requirements, thereby supporting reliable positioning performance. 10

The mapping between each posSibType and its corresponding assistance data element is summarized in Table 1 below.

TABLE 1

| | posSibType | assistanceDataElement |
|---|---|---|
| GNSS Common Assistance Data | posSibType1-1 | GNSS-ReferenceTime |
| | posSibType1-2 | GNSS-ReferenceLocation |
| | posSibType1-3 | GNSS-IonosphericModel |
| | posSibType1-4 | GNSS-EarthOrientationParameters |
| | posSibType1-5 | GNSS-RTK-ReferenceStationInfo |
| | posSibType1-6 | GNSS-RTK-CommonObservationInfo |
| | posSibType1-7 | GNSS-RTK-AuxiliaryStationData |
| | posSibType1-8 | GNSS-SSR-CorrectionPoints |
| | posSibType1-9 | GNSS-Integrity-ServiceParameters |
| | posSibType1-10 | GNSS-Integrity-ServiceAlert |
| | posSibType1-11 | GNSS-LOS-NLOS-GridPoints |
| | posSibType1-12 | GNSS-SSR-IOD-Update |
| GNSS Generic Assistance Data | posSibType2-1 | GNSS-TimeModelList |
| | posSibType2-2 | GNSS-DifferentialCorrections |
| | posSibType2-3 | GNSS-NavigationModel |
| | posSibType2-4 | GNSS-RealTimeIntegrity |
| | posSibType2-5 | GNSS-DataBitAssistance |
| | posSibType2-6 | GNSS-AcquisitionAssistance |
| | posSibType2-7 | GNSS-Almanac |
| | posSibType2-8 | GNSS-UTC-Model |
| | posSibType2-9 | GNSS-AuxiliaryInformation |
| | posSibType2-10 | BDS-DifferentialCorrections |
| | posSibType2-11 | BDS-GridModelParameter |
| | posSibType2-12 | GNSS-RTK-Observations |
| | posSibType2-13 | GLO-RTK-BiasInformation |
| | posSibType2-14 | GNSS-RTK-MAC-CorrectionDifferences |
| | posSibType2-15 | GNSS-RTK-Residuals |
| | posSibType2-16 | GNSS-RTK-FKP-Gradients |
| | posSibType2-17 | GNSS-SSR-OrbitCorrections |
| | posSibType2-17a | GNSS-SSR-OrbitCorrectionsSet2 |
| | posSibType2-18 | GNSS-SSR-ClockCorrections |
| | posSibType2-18a | GNSS-SSR-ClockCorrectionsSet2 |
| | posSibType2-19 | GNSS-SSR-CodeBias |
| | posSibType2-20 | GNSS-SSR-URA |
| | posSibType2-20a | GNSS-SSR-URA-Set2 |
| | posSibType2-21 | GNSS-SSR-PhaseBias |
| | posSibType2-22 | GNSS-SSR-STEC-Correction |
| | posSibType2-23 | GNSS-SSR-GriddedCorrection |
| | posSibType2-24 | NavIC-DifferentialCorrections |
| | posSibType2-25 | NavIC-GridModelParameter |
| | posSibType2-26 | GNSS-LOS-NLOS-GriddedIndications |
| | posSibType2-27 | GNSS-SSR-SatellitePCVResiduals |
| OTDOA Assistance Data | posSibType3-1 | OTDOA-UE-Assisted |
| Barometric Assistance Data | posSibType4-1 | Sensor-AssistanceDataList |
| TBS Assistance Data | posSibType5-1 | TBS-AssistanceDataList |
| NR DL-TDOA/DL- | posSibType6-1 | NR-DL-PRS-AssistanceData |
| AoD/DL AI/ML | posSibType6-2 | NR-UEB-TRP-LocationData |
| Assistance Data | posSibType6-3 | NR-UEB-TRP-RTD-Info |
| | posSibType6-4 | NR-TRP-BeamAntennaInfo |
| | posSibType6-5 | NR-DL-PRS-TRP-TEG-Info |
| | posSibType6-7 | NR-PRU-DL-Info |
| On-demand DL-PRS | posSibType6-6 | NR-On-Demand-DL-PRS-Configurations |
| Configurations | | |
| Integrity Assistance | posSibType7-1 | NR-IntegrityRiskParameters |
| Data for NR | posSibType7-2 | NR-IntegrityServiceParameters |
| Positioning Methods | posSibType7-3 | NR-IntegrityServiceAlert |

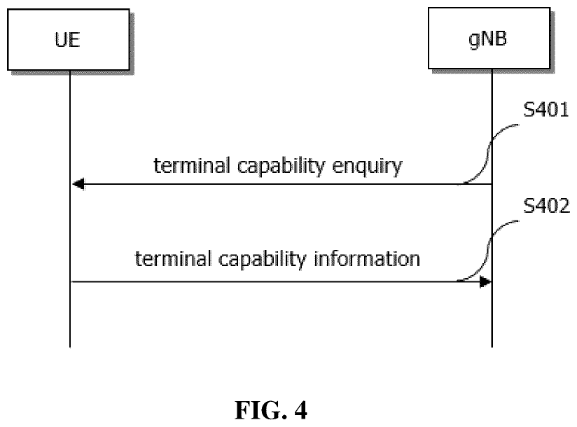

FIG. 4 illustrates a procedure of terminal capability transfer.

The base station (gNB) may initiate the procedure to a terminal (UE) in RRC_CONNECTED when it needs (additional) UE radio access capability information. The base station should retrieve terminal (UE) capabilities only after access stratum (AS) security activation. The base station may not forward terminal (UE) capabilities that were retrieved before AS security activation to the core network (CN). Referring to FIG. 4, a terminal (UE) capability enquiry message is transmitted to request terminal (UE) radio access capabilities for NR as well as for other radio access technologies (S401). The terminal (UE) capability information message is transmitted to transfer terminal (UE) radio access capabilities requested by the base station (S402).

For positioning system information blocks (posSIBs), certain assistance data associated with specific posSIB types may require periodic updates. Accordingly, periodic delivery of such posSIBs may be necessary to ensure the validity and accuracy of positioning information.

When a particular posSIB required by a UE is not currently being broadcast, the UE may transmit an uplink (UL) dedicated RRC message to a serving gNB to request the required posSIB. In response to the request, the gNB may provide the requested posSIB either through dedicated signaling or by broadcasting the posSIB via system information.

However, under existing mechanisms, the network is not explicitly informed of whether periodic delivery of a requested posSIB should be initiated or terminated. In particular, when a UE requests periodic transmission of a posSIB, the network may not have clear information regarding when to stop the periodic delivery. As a result, periodic transmission may continue unnecessarily, or alternatively, may be terminated prematurely without satisfying the UE's positioning requirements.

Accordingly, there is a need for a mechanism that enables the UE to explicitly indicate control information related to periodic delivery of a posSIB, such as an instruction to start or stop the periodic transmission. In some implementations, such control information may further include additional parameters, for example an indication of a desired number of periodic deliveries. By allowing the UE to provide start and stop indications, unnecessary signaling overhead and inefficient radio resource usage may be reduced.

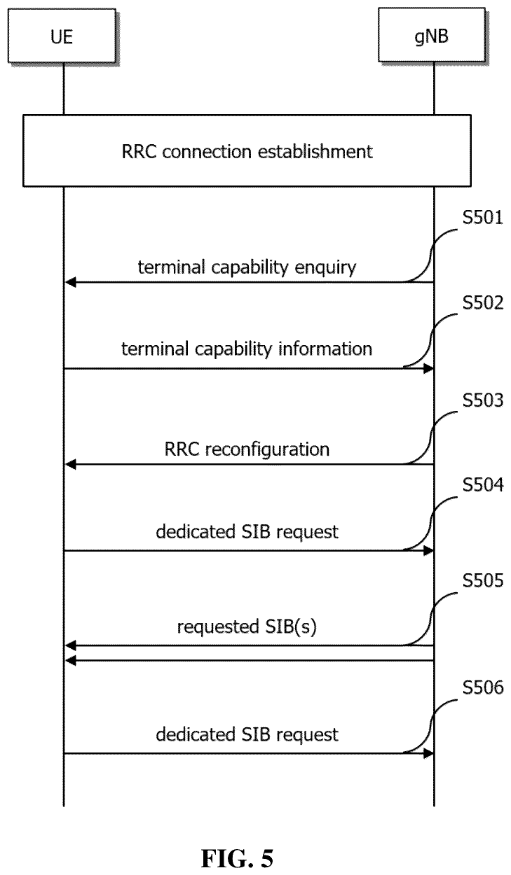

FIG. 5 illustrates a procedure between a terminal and a base station according to an embodiment of the disclosure.

Positioning assistance data may be included in Positioning System Information Blocks (posSIBs). The posSIBs are carried in RRC System Information (SI) messages. The mapping of posSIBs (assistance data) to SI messages is flexibly configurable and provided to the UE in SIB1.

The UE may request posSI by means of on-demand SI request in RRC_IDLE/RRC_INACTIVE and also request posSIBs by means of on-demand SIB request in RRC_CONNECTED. For an on-demand SIB request in RRC_CONNECTED, the UE may request a posSIB and may further include information indicating periodic delivery parameters, for example a desired number of deliveries.

Referring to FIG. 5, the UE establishes an RRC connection with the gNB. The RRC connection establishment may be performed according to a conventional RRC connection establishment procedure.

After the RRC connection is established, the gNB may transmit a terminal capability enquiry message to the UE (S501). In response, the UE may transmit terminal capability information to the gNB (S502). The terminal capability information may include information indicating whether the UE supports the on-demand request procedure of positioning SIBs with control parameters while in RRC_CONNECTED.

Subsequently, the gNB may transmit an RRC reconfiguration message to the UE (S503). The RRC reconfiguration message may include first information indicating that the UE is enabled to request periodic delivery of at least one positioning SIB (posSIB). The first information may be provided only when second information indicating that the UE is allowed to request at least one SIB is included in the RRC reconfiguration message.

Thereafter, when the UE determines that periodic delivery of at least one particular posSIB is required, the UE may transmit a dedicated SIB request message to the gNB (S504). The dedicated SIB request message may include a field indicating that periodic delivery of the requested posSIB is to be started. The field may further indicate the number of periodic deliveries required for the requested posSIB. Here, the information indicating the number of periodic deliveries may be represented by integer value N corresponding to an amount of 2N. N may be an integer selected from 1 to 31.

Upon receiving the dedicated SIB request message, the gNB may transmit the requested SIB(s) to the UE (S505). The gNB may deliver the posSIB either through dedicated signaling or through system information broadcasting, depending on network configuration.

Thereafter, when the UE determines that periodic delivery of at least one particular posSIB is no longer required, the UE may transmit a dedicated SIB request message to the gNB (S506). The field in the dedicated SIB request message may indicate that periodic delivery of the previously requested posSIB is to be stopped. In this case, the integer value may be set to 0 to indicate termination of periodic delivery.

The gNB may terminate periodic transmission of the posSIB when a stop indication is received from the UE or when predefined termination conditions, such as completion of a requested number of deliveries, are satisfied.

Through the above procedure, the network is informed of the UE's required number of periodic deliveries, thereby preventing unnecessary repeated requests from the UE and reducing signaling overhead, while also avoiding excessive resource consumption due to indefinite posSIB transmission.

The above described RRC reconfiguration message may be configured as shown in Table 2.

TABLE 2
-- ASN1START
-- TAG-RRCRECONFIGURATION-START

| | |
|---|---|
| ... | |
| RRCReconfiguration-v1610-IEs ::= | SEQUENCE { |
| ... | |
| onDemandSIB-Request-r16 | SetupRelease { OnDemandSIB-Request- |

| | |
|---|---|
| r16 } | OPTIONAL, -- Need M |

...

| | |
|---|---|
| RRCReconfiguration-v19xy-IEs ::= | SEQUENCE |

| | |
|---|---|
| onDemandPosSIB-RequestCtrlParam-r19 | ENUMERATED { enabled } |

OPTIONAL, -- Need R

| | |
|---|---|
| nonCriticalExtension | SEQUENCE { } |

OPTIONAL
}
...
-- TAG-RRCRECONFIGURATION-STOP
-- ASN1STOP

onDemandSIB-Request: Indicates that the UE is allowed to request SIB(s) on-demand while in RRC_CONNECTED.

onDemandPosSIB-RequestCtrlParam: Indicates whether the UE is enabled to request periodic delivery of posSIB(s) while in RRC_CONNECTED. This field can only be present when the field onDemandSIB-Request is present.

The above described dedicated SIB request message may be configured as shown in Table 3.

TABLE 3
-- ASN1START
-- TAG-DEDICATEDSIBREQUEST-START
...
DedicatedSIBRequest-r16-IEs ::= SEQUENCE {

| | |
|---|---|
| onDemandSIB-RequestList-r16 | SEQUENCE { |

| | |
|---|---|
| requestedSIB-List-r16 | SEQUENCE (SIZE (1..maxOnDemandSIB- |

| | |
|---|---|
| r16)) OF SIB-ReqInfo-r16 | OPTIONAL, |

| | | |
|---|---|---|
| requestedPosSIB-List-r16 | SEQUENCE | (SIZE |

| | |
|---|---|
| (1..maxOnDemandPosSIB-r16)) OF PosSIB-ReqInfo-r16 | OPTIONAL |

} OPTIONAL,

| | | |
|---|---|---|
| lateNonCriticalExtension | OCTET STRING | OPTIONAL |

| | |
|---|---|
| nonCriticalExtension | DedicatedSIBRequest-v19xy-IEs |

OPTIONAL
}
DedicatedSIBRequest-v19xy-IEs ::= SEQUENCE {

| | |
|---|---|
| onDemandPosSIB-RequestList-r19 | SEQUENCE { |

| | | |
|---|---|---|
| requestedPeriodicAD-PosSIB-List-r19 | SEQUENCE | (SIZE |

| | | |
|---|---|---|
| (1..maxOnDemandPosSIB-r16)) | OF | PeriodicAD-PosSIB-ReqInfo-r19 |

OPTIONAL

| | |
|---|---|
| } | OPTIONAL, |

| | |
|---|---|
| nonCriticalExtension | SEQUENCE { } |

OPTIONAL
}

| | |
|---|---|
| SIB-ReqInfo-r16 ::= | ENUMERATED { sib12, sib13, sib14, sib20- |

v1700, sib21-v1700, sib23-v1810, spare2, spare1 }

| | |
|---|---|
| PosSIB-ReqInfo-r16 ::= | SEQUENCE { |

| | | |
|---|---|---|
| gnss-id-r16 | GNSS-ID-r16 | OPTIONAL, |
| sbas-id-r16 | SBAS-ID-r16 | OPTIONAL, |

| | |
|---|---|
| posSibType-r16 | ENUMERATED { posSibType1-1, posSibType1-2, |

posSibType1-3, posSibType1-4, posSibType1-5, posSibType1-6, posSibType1-

| | | | | |
|---|---|---|---|---|
| 7, | posSibType1-8, | posSibType2-1, | posSibType2-2, | posSibType2-3, |

posSibType2-4, posSibType2-5, posSibType2-6, posSibType2-7, posSibType2-

| | | | | |
|---|---|---|---|---|
| 8, | posSibType2-9, | posSibType2-10, | posSibType2-11, | posSibType2-12, |

| | | | |
|---|---|---|---|
| posSibType2-13, | posSibType2-14, | posSibType2-15, | posSibType2-16, |
| posSibType2-17, | posSibType2-18, | posSibType2-19, | posSibType2-20, |
| posSibType2-21, | posSibType2-22, | posSibType2-23, | posSibType3-1, |

posSibType4-1, posSibType5-1, posSibType6-1, posSibType6-2, posSibType6-

| | | | |
|---|---|---|---|
| 3,..., | posSibType1-9-v1710, | posSibType1-10-v1710, | posSibType2-24-v1710, |

| | | |
|---|---|---|
| posSibType2-25-v1710, | posSibType6-4-v1710, | posSibType6-5-v1710, |

| | | |
|---|---|---|
| posSibType6-6-v1710, | posSibType2-17a-v1770, | posSibType18a-v1770, |

| | | |
|---|---|---|
| posSibType2-20a-v1770, | posSibType1-11-v1800, | posSibType1-12-v1800, |
| posSibType2-26-v1800, | posSibType2-27-v1800, | posSibType6-7-v1800, |
| posSibType7-1-v1800, | posSibType7-2-v1800, | posSibType7-3-v1800, |

posSibType7-4-v1800 }
}
PeriodicAD-PosSIB-ReqInfo-r19 ::= SEQUENCE {

| | |
|---|---|
| gnss-id-r19 | GNSS-ID-r16 |

OPTIONAL,

| | |
|---|---|
| sbas-id-r19 | SBAS-ID-r16 |

OPTIONAL,

| | |
|---|---|
| periodicAD-posSibType-r19 | ENUMERATED { posSibType1-10, |

| | | | |
|---|---|---|---|
| posSibType1-12, | posSibType2-12, | posSibType2-13, | posSibType2-14, |
| posSibType2-15, | posSibType2-16, | posSibType2-17, | posSibType2-17a, |
| posSibType2-18, | posSibType2-18a, | posSibType2-19, | posSibType2-20, |
| posSibType2-20a, | posSibType2-21, | posSibType2-22, | posSibType2-23, |

posSibType6-7,... },

| | |
|---|---|
| posSIB-ReqPeriodicControlParam-r19 | PosSIB-ReqPeriodicControlParam- |

r19,
...
}

| | |
|---|---|
| PosSIB-ReqPeriodicControlParam-r19 | ::= SEQUENCE |

| | |
|---|---|
| deliveryAmount-r19 | INTEGER (0..31), |

...
}
-- TAG-DEDICATEDSIBREQUEST-STOP
-- ASN1STOP

requestedSIB-List: Contains a list of SIB(s) the UE requests while in RRC_CONNECTED.

requestedPosSIB-List: Contains a list of posSIB(s) the UE requests while in RRC_CONNECTED.

requestedPeriodicAD-PosSIB-List: Contains a list of posSIB(s) the UE may request with periodic control parameter while in RRC_CONNECTED.

gnss-id: The presence of this field indicates that the request positioning SIB type is for a specific GNSS. Indicates a specific GNSS.

sbas-id: The presence of this field indicates that the request positioning SIB type is for a specific SBAS. Indicates a specific SBAS. If the UE includes this field it shall set gnss-id to sbas.

periodicAD-posSibType: Types of posSIB that the UE may request with periodic control parameter while in RRC_CONNECTED.

deliveryAmount: This field specifies the number of periodic deliveries for the indicated posSIB. Integer values N=1 . . . 30 correspond to an amount of 2N. Integer value N=31 indicates an ‘infinite/indefinite’ amount and integer value N=0 indicates that no more deliveries are needed.

Meanwhile, the following posSIB types may require periodic delivery due to the time-varying characteristics of the assistance data included therein:
posSibType1-10 and posSibType1-12
posSibType2-12, posSibType2-13, posSibType2-14, posSibType2-15, posSibType2-16, posSibType2-17, posSibType2-17a (posSibType2-12bis), posSibType2-18, posSibType2-18a (posSibType2-18bis), posSibType2-19, posSibType2-20, posSibType2-20a (posSibType2-20bis), posSibType2-21, posSibType2-22 and posSibType2-23
posSibType6-7

The above posSIBs generally include assistance data having a relatively short validity duration or dynamically updated correction parameters. Therefore, periodic refresh of such information may be required to maintain positioning accuracy and integrity.

In particular, posSibType1-10 and posSibType1-12 include integrity-related service parameters and SSR-related update information. Such data may reflect satellite health status, correction validity, or service availability conditions, which may change over time. If outdated integrity or correction parameters are used, positioning reliability may be degraded. Accordingly, periodic delivery enables the UE to maintain updated integrity awareness.

Similarly, posSibType2-12 through posSibType2-23 (including their respective variants) include high-precision correction data such as Real-Time Kinematic (RTK) observations, orbit corrections, clock corrections, bias information, User Range Accuracy (URA) parameters, Slant Total Electron Content (STEC) corrections, and residual error compensation values. These parameters are typically generated and refreshed at relatively short intervals in order to support precise positioning services. Since the validity window of such data may be limited, periodic delivery ensures that the UE receives refreshed correction information within its effective time range.

In particular, posSibType6-7 corresponds to New Radio-Positioning Reference Unit-Downlink-Information (NR-PRU-DL-Info) and relates to NR downlink positioning assistance associated with PRS (Positioning Reference Signal) resource unit configuration information.

The information included in posSibType6-7 may define parameters for NR downlink PRS resource allocation, including PRS resource unit configuration, transmission periodicity, time/frequency domain resource mapping, and muting patterns. Such parameters may be adjusted depending on network operating conditions, UE density, traffic load, or positioning session requirements. Accordingly, the PRS configuration information may have a limited temporal validity.

If the UE operates based on outdated PRS resource unit configuration information, positioning measurements may become inconsistent with the current network configuration, which may degrade measurement accuracy or cause positioning procedures to fail. Furthermore, mismatched PRS configuration may lead to inefficient use of radio resources. Therefore, periodic delivery of posSibType6-7 enables the UE to maintain alignment with updated NR downlink PRS configurations and to reliably perform NR-based positioning measurements.

Therefore, posSibType6-7 may require periodic refresh to reflect dynamically updated NR downlink PRS configuration information. This distinguishes posSibType6-7 from other type-6 positioning SIBs that may include relatively static configuration parameters not requiring periodic update.

Accordingly, the procedure described with reference to FIG. 5 is preferably applied at least to posSibType6-7. As described above, posSibType6-7 corresponds to NR-PRU-DL-Info and includes NR downlink PRS resource unit configuration information that may be dynamically updated. Since such PRS configuration parameters may change according to network conditions, UE density, traffic load, or positioning session requirements, the temporal validity of the information may be limited. Therefore, periodic delivery control according to the procedure of FIG. 5 enables the UE to maintain alignment with updated NR downlink PRS configurations while avoiding unnecessary or indefinite transmissions.

In other words, by applying the procedure of FIG. 5 at least to posSibType6-7, the network may be informed of the UE's requirements related to periodic delivery of dynamically updated NR-PRS configuration information (for example, control information such as a desired number of periodic deliveries). This enables the network to terminate periodic transmission at an appropriate time, thereby improving positioning reliability and enhancing radio resource efficiency.

In another embodiment of the present specification, a new positioning system information block type, referred to as posSibType8, is proposed, and a method applicable to the procedure of FIG. 5 is described below. The proposed posSibType8 may be defined as NR-ShortValidity-AD-Info, which is configured to carry positioning assistance data having a relatively short temporal validity and/or being frequently updated depending on network operating conditions. In this embodiment, NR-ShortValidity-AD-Info is distinguished from other posSIB types in that it is intended to convey short-validity, time-sensitive assistance information whose usefulness may rapidly degrade if not refreshed in a timely manner.

NR-Short Validity-AD-Info may include, for example, one or more of (i) a reference time and/or timing tag associated with the assistance data, (ii) a validity duration indicating an effective time window of the assistance data, and (iii) a sequence number (or version indicator) enabling a UE to determine whether the assistance data is newer than previously received data. In addition, NR-ShortValidity-AD-Info may include dynamically varying positioning-related parameters, such as context-dependent configuration hints, session-related control parameters, and/or measurement quality indicators, which may change according to network conditions, UE density, traffic load, or positioning session requirements. Because the assistance data carried by NR-Short Validity-AD-Info may have a limited validity window, periodic refresh of NR-ShortValidity-AD-Info may be required for a UE to maintain up-to-date assistance data during positioning operations.

Accordingly, the procedure described with reference to FIG. 5 is preferably applied at least to posSibType8 (NR-ShortValidity-AD-Info). In particular, when the UE determines that periodic delivery of NR-Short Validity-AD-Info is required, the UE may transmit a dedicated SIB request message to a gNB in an RRC connected state to request periodic delivery of the NR-ShortValidity-AD-Info. The dedicated SIB request message may include a control field indicating that periodic delivery is to be started and may further include information indicating a required number of periodic deliveries. Based on the request, the gNB may periodically provide the NR-ShortValidity-AD-Info to the UE via dedicated signaling and/or via system information, depending on network configuration.

Thereafter, when the UE determines that periodic delivery of NR-ShortValidity-AD-Info is no longer required, the UE may transmit another dedicated SIB request message including a control field indicating that periodic delivery is to be stopped. In response, the gNB may terminate periodic transmission of the NR-ShortValidity-AD-Info. By enabling the UE to indicate the desired number of periodic deliveries and/or to explicitly request termination, the network can avoid indefinite transmission and reduce unnecessary signaling overhead, while allowing the UE to maintain updated short-validity assistance data. As a result, positioning reliability may be improved and radio resource utilization may be enhanced.

In a further embodiment, posSibType8 (NR-Short Validity-AD-Info) is configured such that periodic delivery control for posSibType8 is performed via a medium access control (MAC) control element (CE) even when the UE is in an RRC_CONNECTED state. In conventional mechanisms, control of positioning SIB delivery in the RRC_CONNECTED state is typically performed through RRC-level dedicated signaling. However, due to the short temporal validity and time-sensitive nature of the assistance data carried by posSibType8, higher-layer RRC signaling may introduce additional latency and signaling overhead. Accordingly, in this embodiment, a MAC CE may be configured to include compact control indicators for starting, modifying, or stopping periodic delivery of posSibType8 while the UE remains in the RRC_CONNECTED state. By performing delivery control at the MAC layer, control latency may be reduced and signaling overhead minimized compared to RRC-based control, thereby enabling more responsive and efficient management of short-validity positioning assistance data. In this manner, periodic delivery control for posSibType8 may be implemented differently from positioning SIB types that utilize RRC-level signaling for delivery control.

The disclosure described so far may be implemented through various means. For example, the embodiment may be implemented by hardware, firmware, software, or a combination thereof. Specifically, the implementation will be described below with reference to the accompanying drawing.

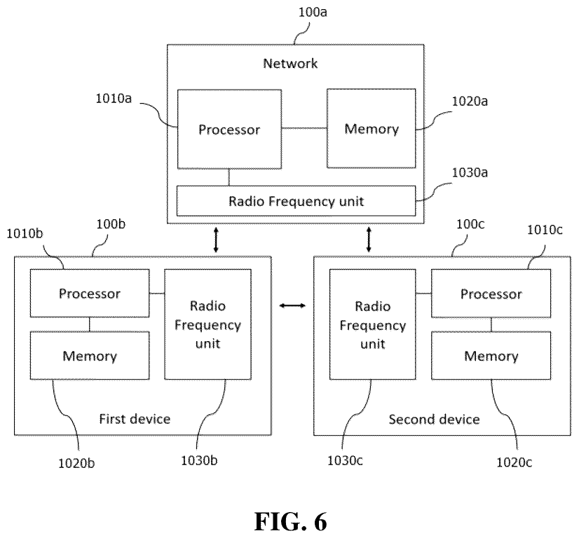

FIG. 6 is a block diagram showing apparatuses according to an embodiment of the disclosure.

Referring to FIG. 6, a wireless communication system may include a network 100a, a first apparatus 100b and a second apparatus 100c.

The network 100a may include a base station, a network node, an apparatus related to 5G service, or other apparatuses related to the fourth industrial revolution.

The first device 100b may include a transmission terminal, a reception terminal, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The second device 100c may include a transmission terminal, a reception terminal, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The network 100a may include at least one processor such as a processor 1010a, at least one memory such as a memory 1020a and at least one radio frequency unit such as a radio frequency unit 1030a. The processor 1010a may be tasked with executing the previously mentioned functions, procedures, and/or methods. The processor 1010a may be capable of implementing one or more protocols. For example, the processor 1010a may perform and manage one or more layers of a radio interface protocol. The memory 1020a may be connected to the processor 1010a, and configured to store various types of information and/or instructions. The radio frequency unit 1030a may be connected to the processor 1010a, and controlled to transceive radio signals.

The first device 100b may include at least one processor such as a processor 1010b, at least one memory such as a memory 1020b and at least one radio frequency unit such as a radio frequency unit 1030b. The processor 1010b may be tasked with executing the previously mentioned functions, procedures, and/or methods. The processor 1010b may be capable of implementing one or more protocols. For example, the processor 1010b may perform and manage one or more layers of a radio interface protocol. The memory 1020b may be connected to the processor 1010b, and configured to store various types of information and/or instructions. The radio frequency unit 1030b may be connected to the processor 1010b, and controlled to transceive radio signals.

The second device 100c may include at least one processor such as a processor 1010c, at least one memory such as a memory 1020c and at least one radio frequency unit such as a radio frequency unit 1030c. The processor 1010c may be tasked with executing the previously mentioned functions, procedures, and/or methods. The processor 1010c may be capable of implementing one or more protocols. For example, the processor 1010c may perform and manage one or more layers of a radio interface protocol. The memory 1020c may be connected to the processor 1010c, and configured to store various types of information and/or instructions. The radio frequency unit 1030c may be connected to the processor 1010c, and controlled to transceive radio signals.

The memory 1020a, the memory 1020b and/or the memory 1020c may be respectively connected inside or outside the processor 1010a, the processor 1010b and/or the processor 1010c and connected to other processors through various technologies such as wired or wireless connection.

According to the embodiment of the disclosure, by explicitly requesting initiation and termination of periodic delivery of a positioning SIB, a terminal may prevent unnecessary repetitive transmissions and improve radio resource efficiency in a wireless communication system.

Although the preferred embodiments of the disclosure have been illustratively described, the scope of the disclosure is not limited to only the specific embodiments, and the disclosure can be modified, changed, or improved in various forms within the spirit of the disclosure and within a category written in the claim.

In the above exemplary systems, although the methods have been described in the form of a series of steps or blocks, the disclosure is not limited to the sequence of the steps, and some of the steps may be performed in different order from other or may be performed simultaneously with other steps. Further, those skilled in the art will understand that the steps shown in the flowcharts are not exclusive and may include other steps or one or more steps of the flowcharts may be deleted without affecting the scope of the disclosure.

Claims of the present disclosure may be combined in various manners. For example, technical features of the method claim of the present disclosure may be combined to implement a device, and technical features of the device claim of the present disclosure may be combined to implement a method. In addition, the technical features of the method claim and the technical features of the device claim of the present disclosure may be combined to implement a device, and technical features of the method claim and the technical features of the device claim of the present disclosure may be combined to implement a method.

What is claimed is:

1. A method for a terminal to operate in a wireless communication system, the method comprising:
receiving, through a first message, first information indicating that the terminal is enabled to request periodic delivery of at least one positioning system information block (SIB);
transmitting, through a second message, a first request requesting the periodic delivery of the at least one positioning SIB according to the first information;
determining that the periodic delivery of the at least one positioning SIB is no longer required; and
transmitting, through the second message, a second request requesting stopping the periodic delivery of the at least one positioning SIB,
wherein the first information is received only when the first message includes second information indicating that the terminal is allowed to request at least one SIB,
wherein the first request and the second request are transmitted using a same field in the second message, and
wherein the at least one positioning SIB comprises, among a positioning SIB of type 6-1, a positioning SIB of type 6-2, a positioning SIB of type 6-3, a positioning SIB of type 6-4, a positioning SIB of type 6-5, a positioning SIB of type 6-6 and a positioning SIB of type 6-7, only the positioning SIB of type 6-7.

2. The method of claim 1, wherein the at least one positioning SIB further comprises at least one selected from a first set consisting of a positioning SIB of type 1-10 and a positioning SIB of type 1-12.

3. The method of claim 1, wherein the at least one positioning SIB further comprises at least one selected from a second set consisting of a positioning SIB of type 2-12, a positioning SIB of type 2-13, a positioning SIB of type 2-14, a positioning SIB of type 2-15, a positioning SIB of type 2-16, a positioning SIB of type 2-17, a positioning SIB of type 2-17bis, a positioning SIB of type 2-18, a positioning SIB of type 2-18bis, a positioning SIB of type 2-19, a positioning SIB of type 2-20, a positioning SIB of type 2-20bis, a positioning SIB of type 2-21, a positioning SIB of type 2-22 and a positioning SIB of type 2-23.

4. A terminal in a wireless communication system comprising:
a processor configured to cause the terminal to:
receive, through a first message, first information indicating that the terminal is enabled to request periodic delivery of at least one positioning system information block (SIB);
transmit, through a second message, a first request requesting the periodic delivery of the at least one positioning SIB according to the first information;
determine that the periodic delivery of the at least one positioning SIB is no longer required; and
transmit, through the second message, a second request requesting stopping the periodic delivery of the at least one positioning SIB,
wherein the first information is received only when the first message includes second information indicating that the terminal is allowed to request at least one SIB,
wherein the first request and the second request are transmitted using a same field in the second message, and
wherein the at least one positioning SIB comprises, among a positioning SIB of type 6-1, a positioning SIB of type 6-2, a positioning SIB of type 6-3, a positioning SIB of type 6-4, a positioning SIB of type 6-5, a positioning SIB of type 6-6 and a positioning SIB of type 6-7, only the positioning SIB of type 6-7.

5. The terminal of claim 4, wherein the at least one positioning SIB further comprises at least one selected from a first set consisting of a positioning SIB of type 1-10 and a positioning SIB of type 1-12.

6. The terminal of claim 4, wherein the at least one positioning SIB further comprises at least one selected from a second set consisting of a positioning SIB of type 2-12, a positioning SIB of type 2-13, a positioning SIB of type 2-14, a positioning SIB of type 2-15, a positioning SIB of type 2-16, a positioning SIB of type 2-17, a positioning SIB of type 2-17bis, a positioning SIB of type 2-18, a positioning SIB of type 2-18bis, a positioning SIB of type 2-19, a positioning SIB of type 2-20, a positioning SIB of type 2-20bis, a positioning SIB of type 2-21, a positioning SIB of type 2-22 and a positioning SIB of type 2-23.
